(19) United States
(12) Patent Application Publication
(10) Pub. No.: US 2007/0271199 A1
(43) Pub. Date: Nov. 22, 2007

(54) Normalization of financial instruments

(76) Inventor: Vijay Kedia, Manhasset, NY (US)

Correspondence Address: John M. Johnson;Carter Ledyard & Milburn LLP, 2 Wall Stree, New York, NY, 10005, US

(21) Appl. No.: 11/438,797

(22) Filed: May 22, 2006

(51) Int. Cl. G06Q 40/00

(52) U.S. Cl. 705/36 R

(57) ABSTRACT

Normalization of more than one financial instrument resident in more than one financial transaction type establishes a correlation or commonality between the aforesaid financial instruments. Algorithmic functionality coupled with visual screen financial data displays expediently make the aforesaid financial data correlation readily apparent to the user.

### BACKGROUND OF THE INVENTION

The present invention relates to normalization of more than one financial instrument in more than one financial transaction type to establish a correlation or commonality therebetween. The subject invention more specifically employs algorithmic functionality coupled with visual screen financial data displays to make the aforesaid financial data correlation readily perceivable to the financial instrument buyer, seller or other trader. This algorithmic functionality can also be applied to create synthetic or virtual instruments based on the relationship between two or more financial instruments.

It is known in the art to present financial data electronically to a user from multiple market sources such as exchanges, banks and other financial market makers. (Additionally, a single source can provide multiple bids and offers. For example an ECN can have 1000 shares bid for MSFT available at $24.03, 5000 shares at $24.02, 3000 shares at $24.01 and so on). This financial data compilation is commonly known as “depth of book” or “level-2 data” Importantly however, this “depth of book” is currently limited in the prior art to the presentation of data of only a single financial instrument (i.e. U.S. Dollar/Euro contracts) in only a single type of financial transaction (i.e. spot market contracts).

In contrast, the subject invention presents to the user the financial data electronically from multiple market sources that pertain to both more than one, not a single, financial instrument (i.e. both U.S. Dollar/Euro contracts and Microsoft stock, by non-limiting example) as well as more than one, not a single, financial transaction type (i.e. both spot market and futures contracts, by non-limiting example), with the financial data of the above different financial instruments and different financial transaction types normalized so that the user can conveniently perceive a correlation or commonality therebetween that assists in the user executing the most desirable or efficient financial transaction.

This commonality, or correlation can be defined and dynamically changed by the user using analytics/rules which can access multiple user defined parameters. For example, as a non-limiting example, a future on Forex SPOT can be represented in equivalent Forex SPOT by user defined forward points for a given future instrument.

### SUMMARY OF THE INVENTION

The subject invention provides a system and method for normalizing financial data using a computer by providing at least one of data for at least more than one financial instrument type and data for at least more than one financial transaction type; (multiple financial instruments can be of same type eg. Microsoft and Google; the transaction type can be same too eg. SPOT prices on GOLD and SILVER) organizing said at least one of data for at least more than one financial instrument type and data for at least more than one financial transaction type into at least first and second data groups based on a financial characteristic common to said data of said first data group and based on a financial characteristic common to said data of said second data group; and normalizing said data of said first data group with respect to said data of said second data group to create a third data group providing one of a financial value commonality and difference of said first data group to said second data group (or creating a resultant synthetic financial instrument {with its own depth of prices} based on the product or relationship between the individual participants).

In the system and method of the subject invention said data of said first data group, said data of said second data group and said data of said third data group (or resultant synthetic instrument) are preferably contemporaneously visually displayed.

In the system and method of the subject invention said at least more than one financial instrument type is preferably selected from the group consisting of stocks, bonds, options, mutual funds, exchange traded funds, precious metal instruments, commodities, and currency exchanges.

In the system and method of the subject invention said at least more than one financial transaction type is preferably selected from the group consisting of the spot market, the futures market, hedges, and forward.

In the system and method of the subject invention said at least one of data for at least more than one financial instrument type and data for at least more than one financial transaction type are preferably obtained in substantially real time from on-line exchanges or real-time price distributors such as banks, brokers and ECNs.

In the system and method of the subject invention a graphical user interface is preferably provided from which a user can execute a financial transaction based on said financial value commonality or difference or relationship of said first data group to said second data group in said third data group.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1A is a block diagram of hardware elements and software modules of an example of an on-line trading hardware and software infrastructure that can be employed with the subject invention;

FIG. 1B is a computer screen shot of an example of a trade execution management system software that can be employed with the subject invention;

FIG. 1C is a software logic flow chart of the order match module, data feed module and execution management system module of the subject invention;

FIG. 2. is a computer screen shot of Level-2 data for a single security;

FIG. 3 is a computer screen shot of Level-2 data integrating and normalizing financial data from multiple financial transaction types for EUR/USD currency financial transactions with the data oriented horizontally;

FIG. 4 is a computer screen shot of Level-2 data integrating and normalizing financial data from multiple financial transaction types for EUR/USD currency financial transactions with the data oriented vertically;

FIG. 5 is a computer screen shot of Level-2 data wherein data of a first financial instrument (AUD/USD) and data of a second financial instrument (AUD/CAD) are employed to create data for a third user defined financial instrument (USA/CAD); and

FIG. 6 is a computer screen shot of Level-2 data based on user predefined financial relationships between predetermined financial instruments as well as predetermined financial transaction types and the deviation from said financial relationships.

### DETAILED DESCRIPTION OF THE PREFERRED EMBODIMENTS

### I. On-Line Trading Hardware

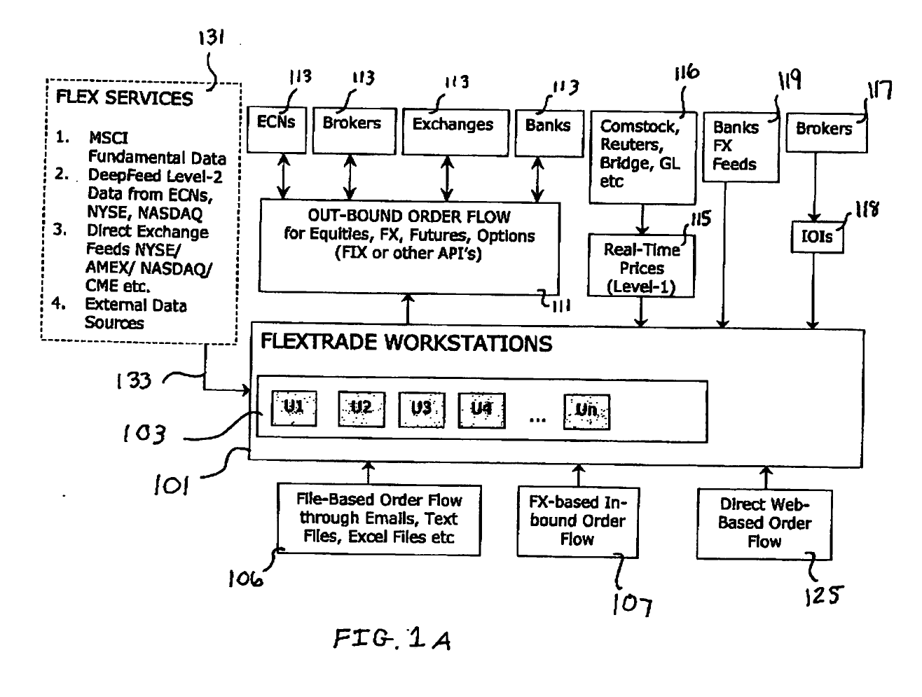

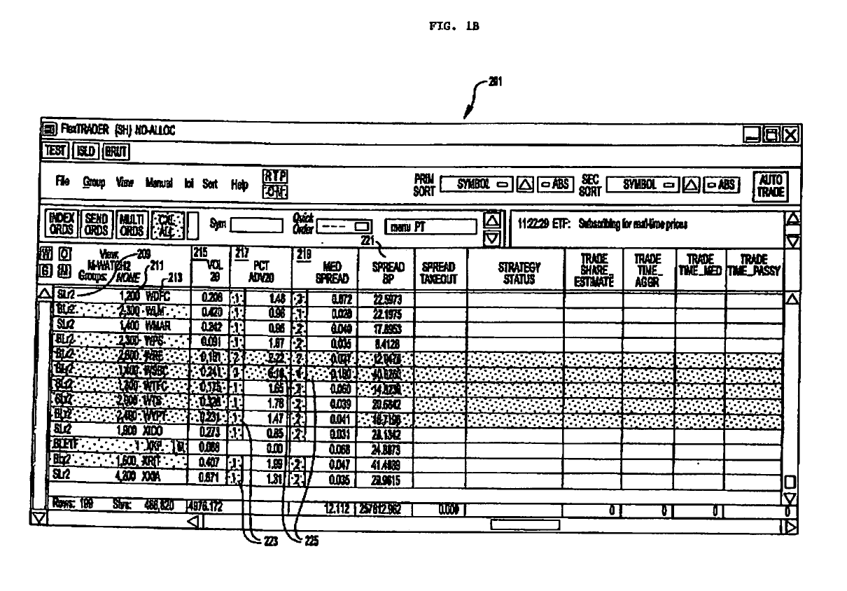

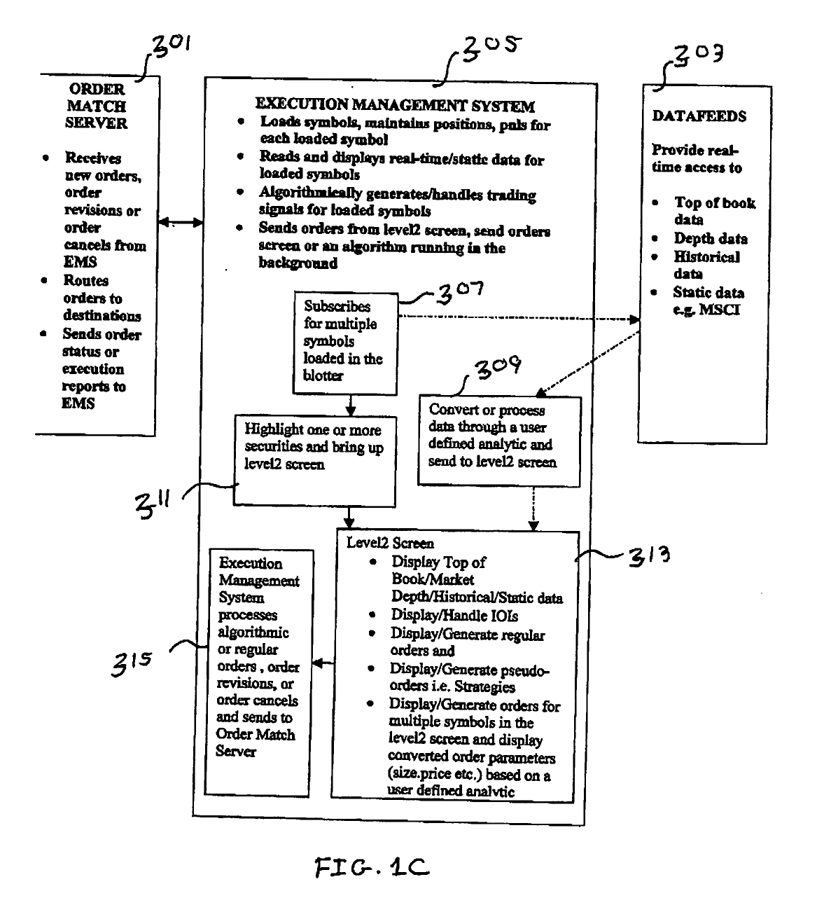

Referring first to FIG. 1A, the hardware elements and software modules of the on-line trading software that can be employed with the subject invention are described. Multiple execution management system work stations 101 are preferably IBM compatible PC computers each having an Intel Pentium-based central processing unit with 512 MB of RAM and a Linux or Microsoft Windows XP operating system. There are preferably multiple user groups 103 running the above workstations, preferably interconnected by a local area network (LAN), with each user group 103 comprised of individual users U₁, U₂ . . . Uₙ. If FlexTrader is the execution management system software program of choice on workstations 101, each of user U₁, U₂ . . . Uₙ, can tailor the graphical user interface of the FlexTrader software program to suit their personal preferences. An API (application program interface) communicates with the users U₁, U₂ . . . Uₙ of each user group 103 and sends and receives data pertaining to, for example, populating financial data columns or obtaining the results of calculations or the results of actions.

Inbound order flow module 107, operating under the FIX protocol engine, accepts incoming orders described further below. There is network interconnection between inbound order flow module 107 and a software router that is preferably a private network or proprietary network such as TNS (transaction network services) that is a secure high speed connection widely used in the financial industry. Via inbound order flow 107 FIX clients communicate via the TNS network and send FIX-based messages to execution management system workstations 101. Also in electronic communication with inbound order flow module 107 is OMS (order management system) such as, for example, Network Cloud, McGregor, Bloomberg, Brass NYFix, Trade Route, which allows the OMS client to review their portfolios.

Direct web based order flow 125 is in communication, or has connectivity with, execution management system 101, that allows web based order flow 125 to interconnect with the execution management system workstations 101 via front end of the web client.

Outbound order flow module 111 includes a FIX-based engine that is in electronic communication with execution management system workstations 101. Outbound order flow module 111 is also in electronic communication with other FIX-based trade destinations 113, such as NYSE, and other brokers or ECNs such as Arca, Island, Brut, Instinet, for example. Trade orders are sent from execution management workstations 101 to outbound order flow module 111, then to one of the trade destinations 113 where the orders are filled or another trade based action happens, which is then relayed back to outbound order flow module 111 with the result being displayed on execution management workstations 101, then continuing to the desired one of the user groups 103 and, finally, to the appropriate one of the users U₁, U₂ . . . Uₙ.

Next referring to real time pricing module 115, which is a consolidator and data re-formatter of prices from different destinations, real time pricing module 115 communicates to execution management system workstations 101, and specifically to a specific ones of user U1, U2 . . . Un. Data vendors 116, such as Reuters and Comstock, provide real time prices on equities and other types of securities to real time pricing protocol 115.

Flex services module 131 communicates with execution management system workstations 101 via transaction network services 133 (TNS), an example of a viable proprietary data network. Flex services module 131 provides: fundamental data, (Morgan Stanley Country Index) a classification of securities bases on industry and sector level; deep feed level 2 data, the specific information from a price feed similar to real time pricing module 115; and level 1 data, again similar to pricing module 115 data and the basic view of security prices.

File based order input 106 is the input of external trade files (or list of trades to be executed) in, for example, text, Excel or ASCII format, to users U1, U2 . . . Un. File based order input 106 is thus in communication with execution management system workstations 101 in order to facilitate trading from brokers 117 through IOI 118 and from bank FX feeds 119.

### II. Execution Management System Graphical User Interface

Next referring to FIG. 1B, an example of a graphical user interface is described for an execution management system, in this example FlexTrader, with which the software of the subject invention communicates. First referring to 201 the main screen of the EMS program is shown. The main FlexTrader “blotter” screen 201 is part of the execution management system described in FIG. 1. The “blotter” is configurable to allow the user to perform specific actions. These actions can be unilateral actions or they can be actions on specific rows of the blotter. The actions performed include computation of a certain value, a screen snap shot, or an actual travel action such as “send an order down to the floor,” “correct an order,” “cancel an order” for example.

Spreadsheet 207 of blotter 201 lists portfolio information in rows identified by, for example, portfolio name (SLR2) 209, the number of shares (1,200) 211 and specific symbol (WDFC) 213. Further regarding portfolio name 209, one possible nomenclature denotes SL as “sell long”, SH for “sell short”, BL for “buy long” and BC for “buy cover”, with r2 in all instances being the specific portfolio identifier.

Columns intersect the above described portfolio rows of spread sheet 207, and each column represents a certain characteristics associated with that specific portfolio. In the first column 215, VOL20, is a measurement of that particular portfolio's volatility per stock. Second column 217, PCT ADV20, is the percentage of an equity's shares to trade relative to its average 20 day volume. For example, if over the last 20 days 100,000 shares are traded on the average a day, then 1,200 shares (element 211) is 1.2% of an average day. Third column 219, MED SPREAD, denotes, on the average, the difference between the buying and selling price of the security. Fourth column 221 denotes SPREAD BP, which is calculated by taking that median spread value and dividing it by the stock price. This value is shown in basis points which is 1/1000 (or 0.1 percent) of the median spread. It is to be understood that the above four share characteristics 215-221 are just examples of share characteristics, they are not intended to be all inclusive. Other characteristics include, by not limiting example, the percent change in the stock price from yesterday's close, profit and loss information in either dollars, basis points or cents per share, difficulty to trade factors, and sector or industry grouping (i.e., technology, a biochemical, biotechnology industry group).

Again referring to column 217, PCT ADV20, there are highlighted ranking numbers 223 (i.e., numbers 1, 2 or 3) in the same cell to the left of the actual PCT ADV number. “Ranking” of ranking numbers 223 is broadly defined as a grouping of specific attributes. For example, all the values in second column 217, PCT ADV20, that are above 1 and below 2 fall into rank 1, and all the values that are above 2 and below 4 fall into rank 2.

Next referring to highlighted rows 225 of a plurality of portfolios, highlighted rows 225 are highlighted by left clicking the mouse, holding the left mouse down, and dragging across the desired number of rows. Alternatively, a computer keyboard button tied to a specific portfolio or to a predetermined characteristic of some portfolios can highlight specific portfolio rows. Next, the highlighted rows 225 can be acted upon by the execution management system software by implementation by the user of one or more of command lines 205 to invoke the computation action associated therewith. The result, in one possibility, being the population or re-population of ranking numbers 223.

### III. Normalization of Financial Instruments Software Logic

Next referring to FIG. 1C, a non-limiting example of the software logic of the protocol for normalization of financial instruments is shown.

Three main processes are present: order match server process 301, data feed server process 303, and execution management system module 305. Both order match server 301 and data feed process 303 are in communication with execution management system module 305.

Order match server module 301 receives new orders, order revisions and order cancellations from execution management system module 305. Order match server module 301 also route the aforesaid orders to the desired, predetermined destinations. Additionally, order match server module 301 transmits order status and order execution reports to execution management system module 305.

Data feed module 303 provides real time access to top of book data, depth data, historical data, and static data (such as, for example, MSCI) through communication with execution management system module 305.

Execution management module 305 loads trading symbols and maintains positions for each loaded symbol, reads and displays both real time and static data for the aforesaid loaded symbols and sends orders from all of the Level-2 screen, send order screen or an algorithm running in the background (invisible to the user). More specifically, at block 307 execution management system module 305 acquires from data feed module 303 multiple trading data for symbols loaded into the blotter. At block 309 this market data, acquired from data feed module 303, is converted and processed through a user defined analytic and is sent to the Level-2 screen by execution management system module 305. In addition to receiving market data from data feed module, the LEVEL 2 screen also receives active orders and IOIs from the EMS. The orders and IOIs are processed through the same user defined analytic before being displayed in the LEVEL 2 screen. Next, at block 311 execution management system module 205 is employed to highlight one or more of the securities associated with the loaded trading data and symbols on the Level-2 screen. At block 313 displays “top of book,” market depth, and historical or static data; displays and processes IOIs; displays and generates standard orders; generates and displays pseudo-orders or trading strategies; and generates and displays algorithmically normalized data for more than one financial instrument employing one or preferably more financial transaction type. At block 315 the order, either standard or algorithmically normalized, is processed (along with order revisions and order cancellations) and sent to order match server module 301.

Instead of a user defined analytic, there can be a system defined parameterized analytic or mathematical expression where the user can control the transformation by changing the parameters used by the said analytic or mathematical expression.

### IV. Normalization of Financial Instruments Graphical User Interface and Function

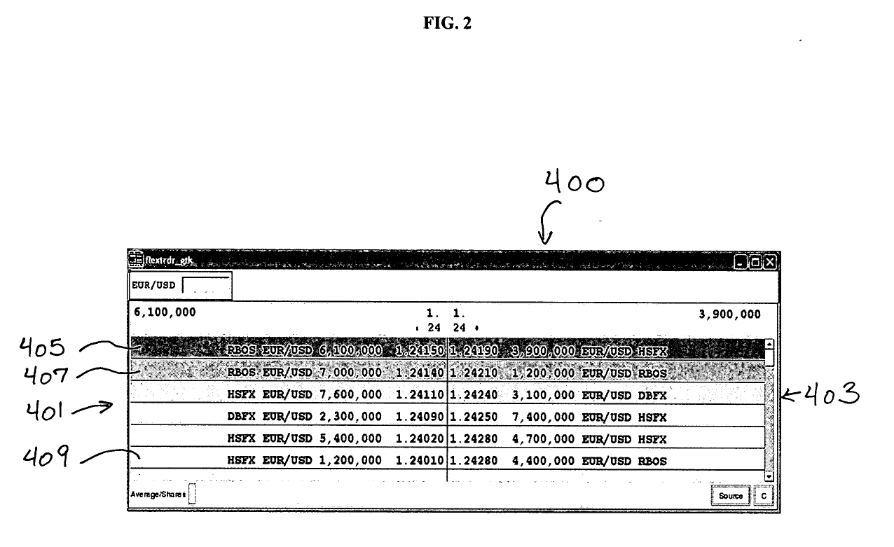

FIG. 2 shows the level-2 data (depth of book) for a single security which is EUR/USD in a computer screen shot 400. Screen shot 400 is prior art that displays level-2 data or depth of book in a single instrument per screen or window.

The left half of 400 shows the bids at 401 and the right half shows the offers and 403. The bids and offers can also be stacked vertically (top/bottom) instead of left/right. The topmost row shows the best bid/offer at 405. The second row from top shows the next best bid/offer at 407. If multiple destinations or price providers show the same bid or offer, they can either be collapsed in a single row or displayed adjacent to each other.

Designate a single cell of data as (priceN, sizeN, is_bid) at 409. N=0 means best-price, N=1 means next best-price and so on. is_bid=1 means it is a bid; is_bid=0 means it is an offer.

Thus:
(price3, size3, 1) is the 4th best BID
(price4, size4, 0) is the 5th best OFFER

The bids and offers come as a real-time feed to the application, but the bids and offers could also be read from a database or memory. Additionally, the transformed bids and offers too can be read from database or memory if the system is designed such that the output of transformation (via user or system analytic) is stored in database or memory.

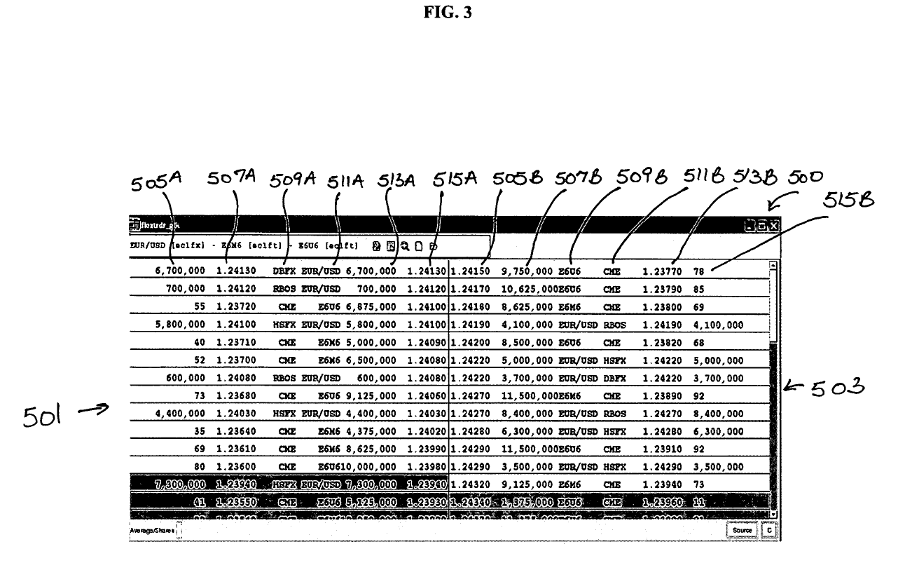

FIG. 3 shows at 500 a computer screen shot integrating and normalizing financial data from multiple financial transaction types. BIDS and OFFERS for EUR/USD (OTC FX Spot), E6U6 (CME Futures contract for EUR/USD), E6M6 (Another CME futures contract for EUR/USD) are all integrated on the same screen 500.

At 501 the left screen half displays BIDS, the right half displays OFFERS (Bids & Offers can be stacked top/bottom instead of left/right) at 503. Also in screen left half 501:

### Column 0: Raw bid size as received by the application (rsizeN) at 505A.

### Column 1: Raw bid price as received by the application (rpriceN) at 507A.

### Column 2: Source for this price (ECN, Exchange, Broker, Bank . . . ) at 509A.

### Column 3: Instrument description at 511A.

### Column 4: Processed/Normalized size (sizeN) at 513A.

### Column 5: Processed/Normalized price (priceN) at 515A.

In screen right half 503 column 0 through 5 attributes are repeated as 505B, 507B, 509B, 511B, 513B, and 515B.

Importantly, every bid/offer received by the application (rsizeN, rpriceN, is_bid=0/1) is processed by a user or system defined rule/analytic/algorithm to transform to (sizeN, priceN, is_bid=0/1) whereby:

(rsizeN, rpriceN, ris_bid)=>{user/system defined rule/analytic/algorithm+input parameter to the rule/analytic/algorithm)=>(sizeN, priceN, is_bid)

The input parameters to the rule could be (but are not limited to) transaction fees, forward points, attributes of the instrument {expiration date, contract multiplier, interest rate, dividend projections, etc.). All or some of the tick attributes can be changed:

For example the size may remain unchanged but the price may change. ris_bid may change from (0 to 1) or (1 to 0) or remain unchanged. If changed, a bid can become offer or vice versa.

The salient features of the subject invention are:
1) Full control by the user to merge any set of different, multiple financial transaction types and of fungible or non-fungible instruments in a single screen or window such that the user need not worry which instrument he is trading, but focus on obtaining the best price for the amount (size) he wants to trade, knowing that all prices have been normalized or transformed.
2) Full control with user to define in real-time the processing/transformation logic/rule that is applied to every price tick that is received.
3) Thus the user can create composite level-2 screens consisting of multiple tradable instruments and different, multiple financial transaction types sorted by the transformed prices/sizes.
4) The user can create prices for synthetic or virtual instruments (product of multiple tradeable instruments) by algorithmic processing. As an example, a highly illiquid resulting instrument can be a combination of two liquid instruments.
   The following is a non-limiting example of an algorithm of the subject invention:

// SAMPLE rule/analytic executed on every tick received
transform_price_tick( )
{
char reference_symbol[30];
char symbol[30];
double price, size;
int is_bid;
double new_price, new_size;
int new_is_bid;
// GET TICK INFORMATION
Get_reference_symbol(reference_symbol);
Get_tick_params(symbol, price, size, is_bid);
// do not process if the price tick is for reference symbol
if(strcmp(symbol, reference_symbol) == 0)
return;
// PROCESS the TICK
new_price = process_price(symbol, reference_symbol, price, is_bid);
new_size = process_size(symbol, reference_symbol, size, price,is_bid);
new_is_bid = process_bid(symbol, is_bid);
// SET PROCESSED TICK INFORMATION
Set_tick_params(symbol, new_price, new_size, new_is_bid);
}

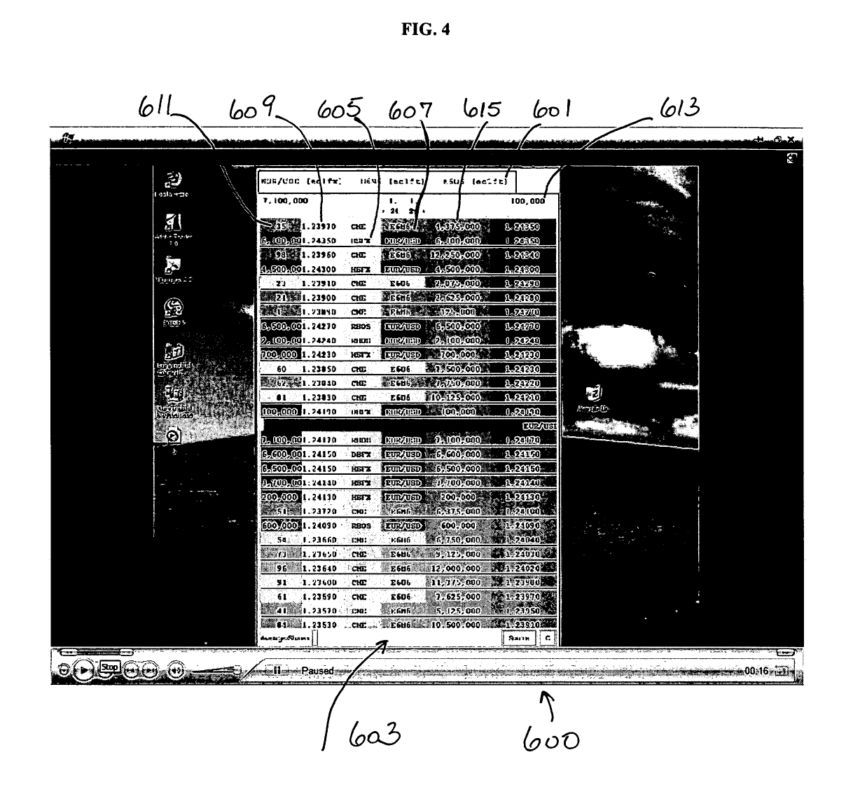

Next referring to FIG. 4, at 600 computer screen shot is shown, which is similar to computer screen shot 500 of FIG. 3 but is oriented vertically instead of horizontally. In screen shot 600 there are multiple levels of prices, on the top are all the bids at 601 and on the bottom below the center point are all the offers at 603.

Again in FIG. 4 the subject invention is merging, or combining multiple transaction types in the same screen 600. The third column 605 shows cbs, cme, rbos, ssfx, and so on. These are the various price providers. Cme is providing prices for the futures on the Forex SPOT, while all the other providers are banks or ecns giving the spot prices on the same Forex SPOT for Euro/US Dollar. While in the columns at 607 E6U6, are different futures on the same Forex SPOT for Euro, expiring at different times of the year. The first two columns show the original price 609 and size 611. Note that the futures numbers are much smaller, 78, 31, 24 and so on, but the Forex SPOT values are in millions. In the right most two columns 613 and 615, the futures price are translated and normalized into the equivalent spot price at 613 based on the interest rate and the expiration duration of the futures. Similarly, at 615 the number of contracts is multiplied by the contract multiplier to convert it into the equivalent spot price in Euros or Dollars.

Thus, the subject invention has translated the futures into equivalent spot price and is showing them all in the same table, or the same depth of book. Now, a trader can really make a better decision regarding which is cheaper to buy because he no longer cares whether he's buying the future or the spot as long as he gets the most attractive price and liquidity/size combination. The same concept is applicable in the subject invention to multiple stocks, to precious metals, to bonds and to commodities, by non limiting example (i.e. different financial instruments as opposed to different financial transaction types such as spot and futures). As long as there is some relationship, price from one financial instrument or financial transaction type can be translated into equivalent price for the other. Thus, in the subject invention every input price and size can be transformed or translated into an equivalent price and size, so that this depth of book is normalized. Hence, a trader can click on a row of computer screen 600 without being concerned whether he's buying a future or a spot and in terms of the price, priority and liquidity, the trader knows that he is indeed buying at the best price because the normalized price is shown.

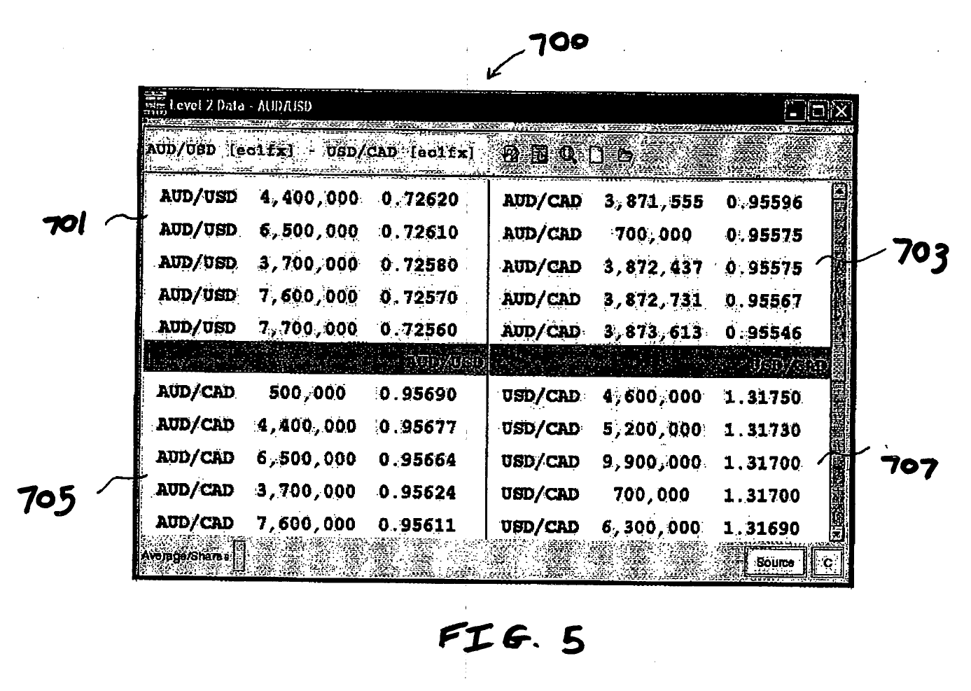

FIG. 5 is a computer screen shot 700 of Level-2 data wherein data of a first financial instrument (AUD/USD) and data of a second financial instrument (AUD/CAD) are employed to create data for a third user defined financial instrument (USA/CAD). This type of Level-2 data of the subject invention allows users to create and monitor synthetic or “virtual” securities formed from the combination/transformation of one or more assets. This can be used to represent a combination/transformation of one or more assets in terms of a new “virtual” security, study and view market movements of a virtual security in realtime and price a new virtual security that is being marketed to investors in an OTC market. Users for this aspect of the subject invention include trading desks at financial institutions that market derivative instruments that represent a combination of underlying assets. For example, a credit derivative desk may use this to price up a spread or a hedge between two or more credit instruments. Alternatively, as shown in FIG. 5, bank can create a synthetic FX spot cross rate out of two underlying spots—e.g. AUD/USD FX spot 701 combined with USD/CAD FX spot 703, 705 to create AUD/CAD FX spot 707. The following is a non-limiting example of a computer algorithm of the present embodiment of FIG. 5 of the subject invention:

```
// ANALYTIC to create prices & sizes for AUD/CAD based on level-2
// prices for AUD/USD and USD/CAD
// INPUTS: price, size, is_bid, is_primary;
// OUTPUT: modified price, size, is_bid;
xform_price_tick( )
{
char symbol[30];
double price, size;
int is_bid, is_primary;
// GET INFORMATION ABOUT NEW TICK
Get_tick_params(symbol, price, size, is_bid, is_primary);
if(is_primary ){ // do not process the tick, no change
        return TRUE;
}
else {
        double val=0,valsize=0;
        if(is_bid){
                val = Pair_Value(“ASK”);
                valsize = Pair_Value(“ASK_SIZE”);
        } else {
                val = Pair_Value(“BID”);
                valsize = Pair_Value(“BID_SIZE”);
        }
        if(is_bid)
        {
                size = (size*price < valsize ? size : valsize/price);
                price = val*price;
        }
        else
        {
                size = (size*price < valsize ? size : valsize/price);
                price = val*price;
        }
        price = ABS(price);
        is_bid = !is_bid;
        // SET PROCESSED TICK INFORMATION
        Set_tick_params(price, size, is_bid);
        return TRUE;
}
}
```

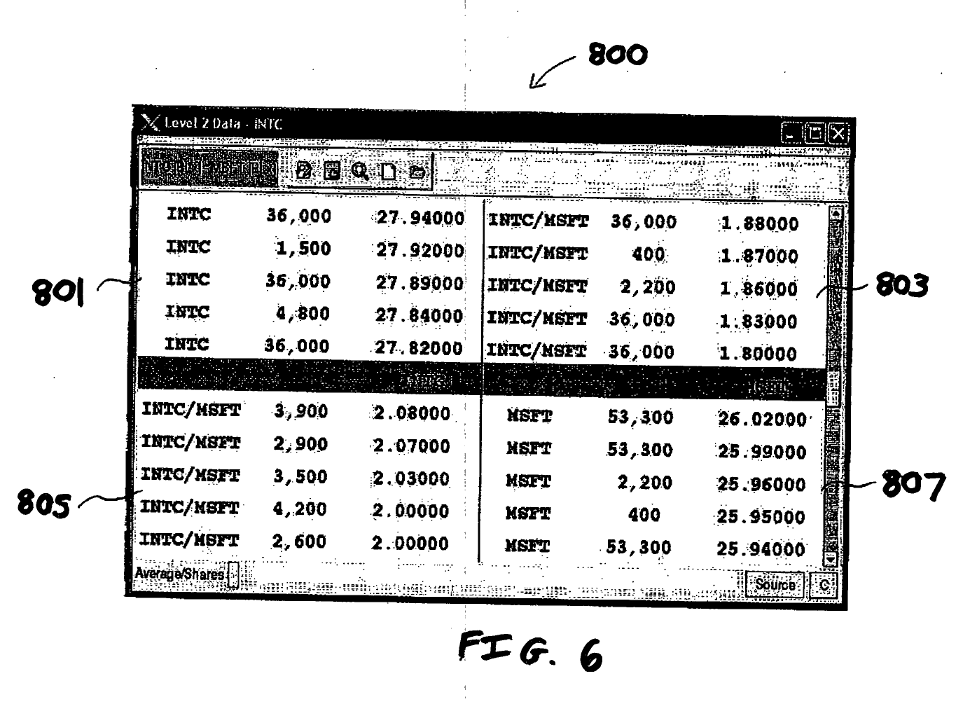

FIG. 6 is a computer screen shot 800 of Level-2 data based on user predefined financial relationships based on predetermined financial instruments as well as predetermined financial transaction types and the deviation from said financial relationships. The rules and analytics of the subject invention can thus also be employed to show relationships between two or more financial instruments such as stocks, bonds mutual funds, ETFs, by non-limiting example, as well as transaction types such as, by non-limiting example, bids, offers and spreads. For example: the ratio of prices between two or more stocks or other financial instruments or the spread of prices between two or more stocks or other financial instruments can be provided by the subject invention. Financial instrument traders can make quick trading decisions employing the present invention because they are provided a correlation between the securities and, importantly, deviation from such correlation. Note the inherent flexibility whereby any mathematical relationship between multiple financial instruments can be displayed in the subject invention. For example, as shown in FIG. 6 INTC offers 801, MSFT bids 807 as well as spread between INTC offers and MSFT bids 803, 805 are provided. The following is a non-limiting example of a computer algorithm of the present embodiment of FIG. 6 the subject invention:

```
// ANALYTIC to display spread between MSFT and INTC based on
// level-2 prices for MSFT and INTC
// INPUTS: price, size, is_bid, is_primary;
// OUTPUT: modified price, size, is_bid;
xform_price_tick( )
{
char symbol[30];
double price, size;
int is_bid, is_primary;
// GET INFORMATION ABOUT NEW TICK
Get_tick_params(symbol, price, size, is_bid, is_primary);
if(is_primary ){ // do not process the tick, no change
        return TRUE;
}
else {
        double val=0,valsize=0;
        if(is_bid){
                val = Pair_Value(“ASK”);
                valsize = Pair_Value(“ASK_SIZE”);
        } else {
                val = Pair_Value(“BID”);
                valsize = Pair_Value(“BID_SIZE”);
        }
        if(is_bid)
        {
                price = val − price;
                size = MIN(size, valsize);
        }
        else
        {
                price = price − val;
                size = MIN(size, valsize);
        }
        price = ABS(price);
        is_bid = !is_bid;
        // SET PROCESSED TICK INFORMATION
        Set_tick_params(price, size, is_bid);
        return TRUE;
}
}
```

We claim:

1. A method for normalizing financial data using a computer comprising:
providing at least one of data for at least more than one financial instrument type and data for at least more than one financial transaction type;
organizing said at least one of data for at least more than one financial instrument type and data for at least more than one financial transaction type into at least first and second data groups based on a financial characteristic common to said data of said first data group and based on a financial characteristic common to said data of said second data group; and
normalizing said data of said first data group with respect to said data of said second data group to create a third data group providing one of a financial value commonality and difference of said first data group to said second data group.

2. The method of claim 1 wherein said data of said first data group, said data of said second data group and said data of said third data group are contemporaneously visually displayed.

3. The method of claim 1 wherein said at least more than one financial instrument type is selected from the group consisting of stocks, bonds mutual funds, exchange traded funds, precious metal instruments, currency exchanges, and electronically traded futures.

4. The method of claim 1 wherein said at least more than one financial transaction type is selected from the group consisting of the spot market, the futures market, hedges, and forwards.

5. The method of claim 1 wherein said at least one of data for at least more than one financial instrument type and data for at least more than one financial transaction type are obtained in substantially real time from on-line exchanges, brokers, banks, ECNs.

6. The method of claim 1 further comprising providing a graphical user interface from which a user can execute a financial transaction based on said financial value commonality or difference of said first data group to said second data group in said third data group.

7. A method for normalizing financial data using a computer comprising:
providing at least one of data for at least more than one financial instrument type and data for at least more than one financial transaction type;
organizing said at least one of data for at least more than one financial instrument type and data for at least more than one financial transaction type into at least first and second data groups based on a financial characteristic common to said data of said first data group and based on a financial characteristic common to said data of said second data group;
normalizing said data of said first data group with respect to said data of said second data group to create a third data group providing one of a financial value commonality and difference of said first data group to said second data group; and
contemporaneously visually displaying said data of said first data group, said data of said second data group and said data of said third data group.

8. The method of claim 7 wherein said at least more than one financial instrument type is selected from the group consisting of stocks, bonds mutual funds, exchange traded funds, precious metal instruments, currency exchanges, and electronically traded futures.

9. The method of claim 7 wherein said at least more than one financial transaction type is selected from the group consisting of the spot market, the futures market, hedges, and forwards.

10. The method of claim 7 wherein said at least one of data for at least more than one financial instrument type and data for at least more than one financial transaction type are obtained in substantially real time from on-line exchanges, brokers, banks, ECNs.

11. The method of claim 7 further comprising providing a graphical user interface from which a user can execute a financial transaction based on said financial value commonality or difference of said first data group to said second data group in said third data group.

12. A method for normalizing financial data using a computer comprising:
providing at least one of data for at least more than one financial instrument type and data for at least more than one financial transaction type;
organizing said at least one of data for at least more than one financial instrument type and data for at least more than one financial transaction type into at least first and second data groups based on a financial characteristic common to said data of said first data group and based on a financial characteristic common to said data of said second data group;
normalizing said data of said first data group with respect to said data of said second data group to create a third data group providing one of a financial value commonality and difference of said first data group to said second data group; and
providing a graphical user interface from which a user can execute a financial transaction based on said financial value commonality or difference of said first data group to said second data group in said third data group.

13. The method of claim 12 wherein said data of said first data group, said data of said second data group and said data of said third data group are contemporaneously visually displayed.

14. The method of claim 12 wherein said at least more than one financial instrument type is selected from the group consisting of stocks, bonds mutual funds, exchange traded funds, precious metal instruments, currency exchanges, and electronically traded futures.

15. The method of claim 12 wherein said at least more than one financial transaction type is selected from the group consisting of the spot market, the futures market, hedges, and forwards.

16. The method of claim 12 wherein said at least one of data for at least more than one financial instrument type and data for at least more than one financial transaction type are obtained in substantially real time from on-line exchanges, brokers, banks, ECNs.

17. A system for normalizing financial data using a computer comprising:
a component for providing at least one of data for at least more than one financial instrument type and data for at least more than one financial transaction type;
a component for organizing said at least one of data for at least more than one financial instrument type and data for at least more than one financial transaction type into at least first and second data groups based on a financial characteristic common to said data of said first data group and based on a financial characteristic common to said data of said second data group; and
a component for normalizing said data of said first data group with respect to said data of said second data group to create a third data group providing one of a financial value commonality and difference of said first data group to said second data group.

18. The system of claim 17 wherein said data of said first data group, said data of said second data group and said data of said third data group are contemporaneously visually displayed.

19. The system of claim 17 wherein said at least more than one financial instrument type is selected from the group consisting of stocks, bonds mutual funds, exchange traded funds, precious metal instruments, currency exchanges, and electronically traded futures.

20. The system of claim 17 wherein said at least more than one financial transaction type is selected from the group consisting of the spot market, the futures market, hedges, and forwards.

21. The system of claim 17 wherein said at least one of data for at least more than one financial instrument type and data for at least more than one financial transaction type are obtained in substantially real time from on-line exchanges, brokers, banks, ECNs.

22. The system of claim 17 further comprising providing a graphical user interface from which a user can execute a financial transaction based on said financial value commonality or difference of said first data group to said second data group in said third data group.

23. A system for normalizing financial data using a computer comprising:
a component for providing at least one of data for at least more than one financial instrument type and data for at least more than one financial transaction type;
a component for organizing said at least one of data for at least more than one financial instrument type and data for at least more than one financial transaction type into at least first and second data groups based on a financial characteristic common to said data of said first data group and based on a financial characteristic common to said data of said second data group;
a component for normalizing said data of said first data group with respect to said data of said second data group to create a third data group providing one of a financial value commonality and difference of said first data group to said second data group; and
a component for contemporaneously visually displaying said data of said first data group, said data of said second data group and said data of said third data group.

24. The system of claim 23 wherein said at least more than one financial instrument type is selected from the group consisting of stocks, bonds mutual funds, exchange traded funds, precious metal instruments, currency exchanges, and electronically traded futures.

25. The system of claim 23 wherein said at least more than one financial transaction type is selected from the group consisting of the spot market, the futures market, hedges, and forwards.

26. The system of claim 23 wherein said at least one of data for at least more than one financial instrument type and data for at least more than one financial transaction type are obtained in substantially real time from on-line exchanges, brokers, banks, ECNs.

27. The system of claim 23 further comprising providing a graphical user interface from which a user can execute a financial transaction based on said financial value commonality or difference of said first data group to said second data group in said third data group.

28. A system for normalizing financial data using a computer comprising:
a component for providing at least one of data for at least more than one financial instrument type and data for at least more than one financial transaction type;
a component for organizing said at least one of data for at least more than one financial instrument type and data for at least more than one financial transaction type into at least first and second data groups based on a financial characteristic common to said data of said first data group and based on a financial characteristic common to said data of said second data group;
a component for normalizing said data of said first data group with respect to said data of said second data group to create a third data group providing one of a financial value commonality and difference of said first data group to said second data group; and
a component for providing a graphical user interface from which a user can execute a financial transaction based on said financial value commonality or difference of said first data group to said second data group in said third data group.

29. The system of claim 28 wherein said data of said first data group, said data of said second data group and said data of said third data group are contemporaneously visually displayed.

30. The system of claim 28 wherein said at least more than one financial instrument type is selected from the group consisting of stocks, bonds mutual funds, exchange traded funds, precious metal instruments, currency exchanges, and electronically traded futures.

31. The system of claim 28 wherein said at least more than one financial transaction type is selected from the group consisting of the spot market, the futures market, hedges, and forwards.

32. The system of claim 28 wherein said at least one of data for at least more than one financial instrument type and data for at least more than one financial transaction type are obtained in substantially real time from on-line exchanges, brokers, banks, ECNs.
